(19) United States
(12) Patent Application Publication
(10) Pub. No.: US 2006/0289595 A1
(43) Pub. Date: Dec. 28, 2006

(54) Nailer with an illumination device

(75) Inventors: Yao Sheng Shen, Taichung City (TW); Sunking Hung, Taichung City (TW); Leo Huang, Taichung City (TW); Sam Yu, Taichung City (TW)

Correspondence Address: CHARLES E. BAXLEY, ESQ., 90 JOHN STREET, THIRD FLOOR, NEW YORK, NY, 10038, US

(73) Assignee: Basso Industry Corp.

(21) Appl. No.: 11/169,611

(22) Filed: Jun. 28, 2005

(51) Int. Cl. B25C 5/06

(52) U.S. Cl. 227/8; 227/119; 227/156

(57) ABSTRACT

A nailer with an illumination device comprises a nailer and an illumination device. The nailer having a muzzle defined at a front end of a housing thererof, between the muzzle and the housing is arranged a panel and a protection hood covered on the panel, and on the protection hood being formed a notch aligned with the muzzle. The illumination device is disposed beneath the protection hood of the nailer and located correspondingly to the notch.

### BACKGROUND OF THE INVENTION

1. Field of the Invention

The present invention relates to a nailer with an illumination device, and more particularly to a nailer whose illumination device is located beneath a protection hood and the light of the illumination device can be projected onto the muzzle and the object to be nailed.

2. Description of the Prior Arts

Nailer as a power tool has been widely used in different activities: such as house decoration, furniture manufacture, box sealing. In application, nailer is sometimes used under a poor illumination condition, especially when nailing a work piece with grooves or holes, or when the light is blocked by the object to be operated, things will get worse. Working in a poor illumination condition will not only affect the nailing operation but also will increase the risk of accident.

The problem will be fixed if the nailer can be provided with an illumination device. However, at which position of the nailer the illumination device can be properly fixed will be another problem, because of the following factors:

First, putting the illumination device on the handle portion of the nailer will make gripping uncomfortable, besides, the distance between the handle portion and the muzzle of the nailer is large, so that the light of the illumination device is difficult to be projected onto the muzzle or the object to be operated.

Second, if fixing the illumination device on the muzzle panel of the nailer, it will make it difficult to open the muzzle panel when the nail get jammed.

Third, if fixing the illumination device on the magazine, then the illumination device cannot be used when replacing the magazine or reloading.

Fourth, if the illumination device is fixed on the housing of the nailer, it will protrude out of the surface of the nailer and may be impacted during application.

Fifth, the illumination device must be set at a proper position, not too far and not too close to the muzzle, otherwise, the light cannot be projected onto the right space between the muzzle and the object to be operated.

### SUMMARY OF THE INVENTION

The primary objective of the present invention is to provide a nailer with an illumination device whose illumination device is located beneath a protection hood and the light of the illumination device can be projected onto the muzzle and the object to be nailed, thus providing the user an optimum light resource.

The secondary objective of the present invention is to provide a nailer with an illumination device whose illumination device is protected from impact by the protection hood.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a nailer with an illumination device in accordance with the present invention;

FIG. 2 shows that the protection hood of the nailer with an illumination device in accordance with the present invention is being opened;

FIG. 3 is an operational view of the nailer with an illumination device in accordance with the present invention;

FIG. 4 shows that the protection hood of another nailer with an illumination device in accordance with the present invention is being removed;

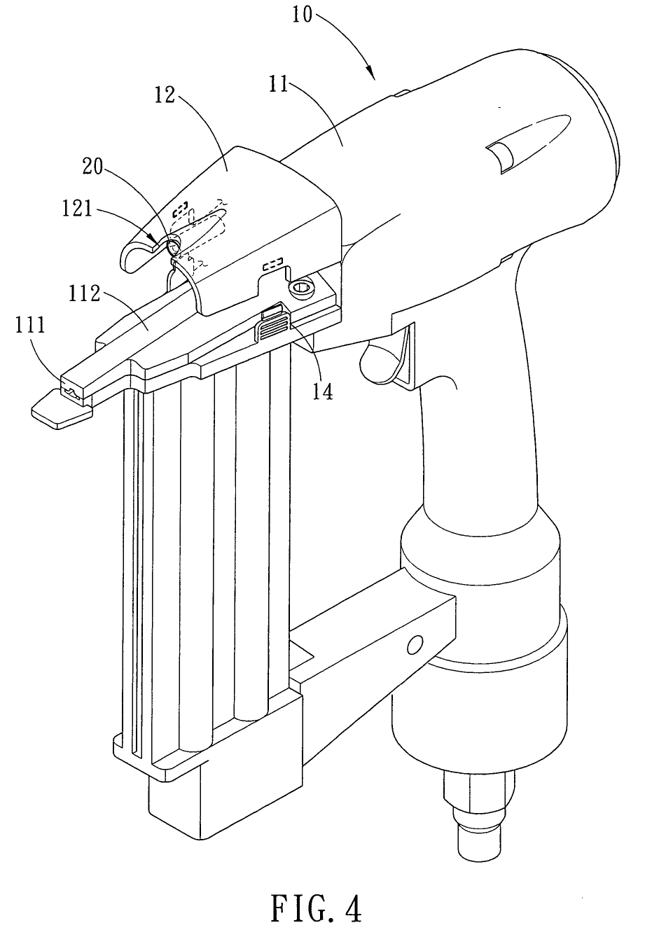

FIG. 5 is a perspective view of a nailer with an illumination device in accordance with another embodiment of the present invention.

### DETAILED DESCRIPTION OF THE PREFERRED EMBODIMENTS

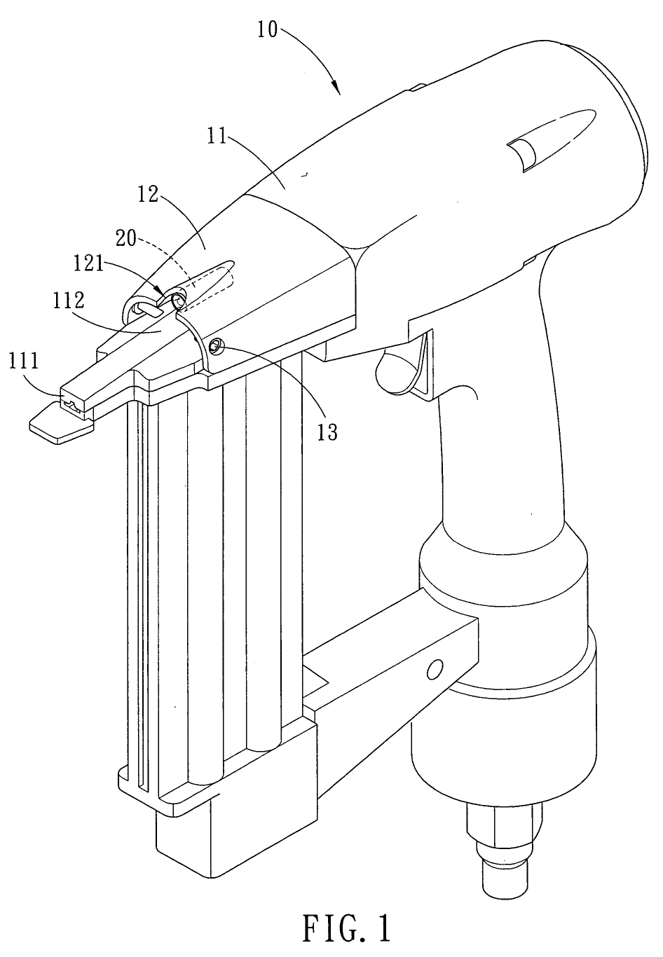

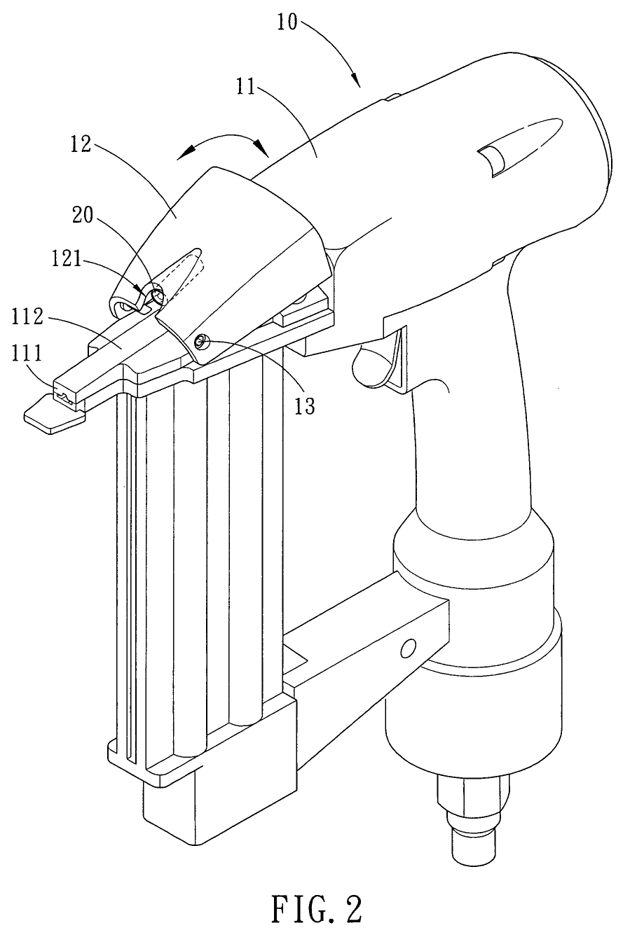

To achieve the aforementioned objects, the present invention provides a nailer with an illumination device, as shown in FIGS. 1 and 2, the illumination device is disposed in the protection hood of the nailer.

The nailer 10 has a muzzle 111 defined at the front end of a housing 11 thereof, through the muzzle 111 nail is slammed out of the nailer 10. Between the muzzle 111 and the housing 11 is a panel 112 that is covered with a protection hood 12, and the protection hood 12 is pivotally fixed to the housing 11 by a pivot 13. On the protection hood 12 is formed a notch 121 that is aligned with the muzzle 111.

The illumination device 20 is disposed beneath the protection hood 12 of the nailer 10 and located correspondingly to the notch 121.

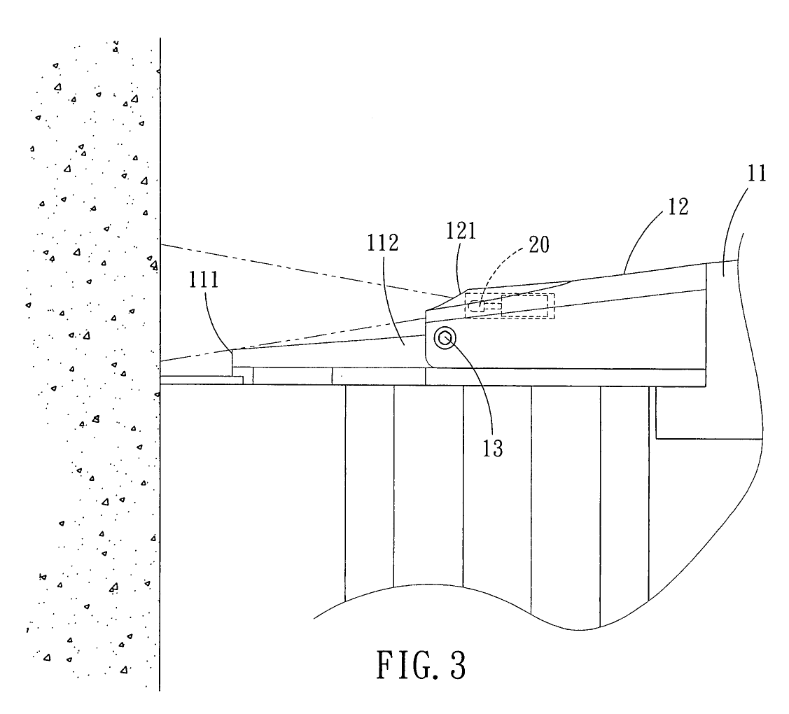

When the illumination device 20 is turned on, light will be projected to the muzzle 111 and the object to be operated via the notch 121 of the protection hood 12. The distance between illumination device and the muzzle 111 is such that the light of the illumination device will form a projection area on the object to be operated, thus providing the user an optimum light source (as shown in FIG. 3).

It is to be noted that impact is inevitable during nailing operation, so that the illumination device 20 can be prevented from damages caused thereby since it is under the protection of the protection hood 12. Furthermore, the protection hood 12 is a known component of the nailer 10, therefore, arranging the illumination device 20 beneath the protection hood 12 doesn't need to add any extra structure to the nailer, but also can provide an optimum illumination position for the nailer.

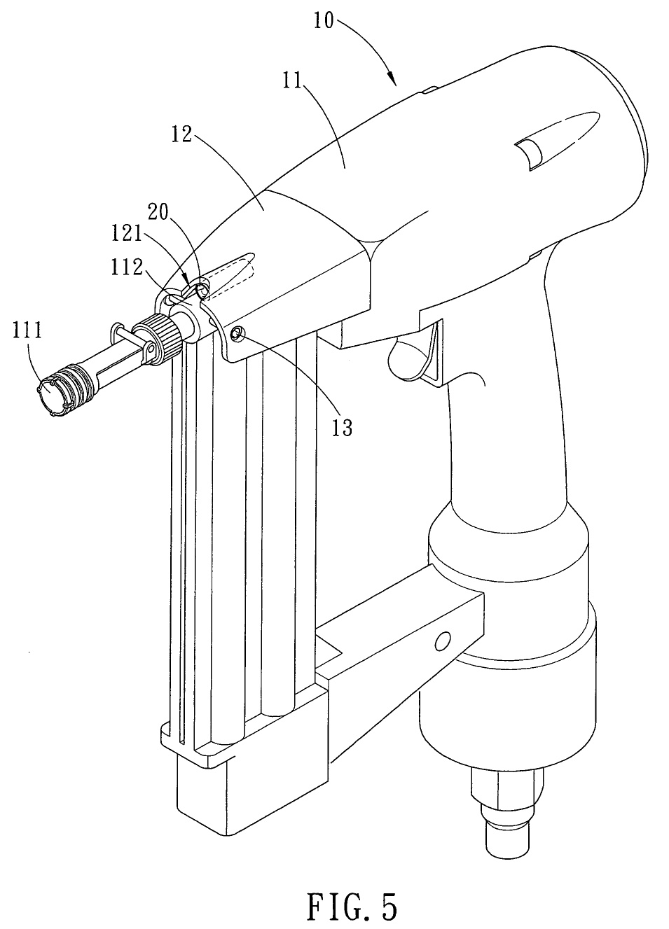

In addition, the arrangement of the illumination device beneath the protection hood is almost applicable to all kinds of nailers. For example, the nailer as shown in FIG. 1 is a flat muzzle type nailer, while the nailer in FIG. 5 is a tubular muzzle type nailer.

Referring back to FIG. 1, since the protection hold 12 is pivotally fixed to the nailer 10 by the pivot 13, illumination maintenance can be done easily by turning up the protection hood 12 (as shown in FIG. 2). In addition, the protection hood 12 also can be secured to the nailer 10 by a locking mechanism 14.

While we have shown and described various embodiments in accordance with the present invention, it should be clear to those skilled in the art that further embodiments may be made without departing from the scope of the present invention.

What is claimed is:

1. A nailer with an illumination device comprising:
a nailer having a muzzle defined at a front end of a housing thererof, between the muzzle and the housing arranged a panel and a protection hood covered on the panel, on the protection hood being formed a notch aligned with the muzzle;
an illumination device disposed beneath the protection hood of the nailer and located correspondingly to the notch.

2. The nailer with an illumination device as claimed in claim 1, wherein the protection cover is pivotally secured to the nailer by a pivot.

3. The nailer with an illumination device as claimed in claim 1, wherein the protection cover is secured to the nailer by a locking mechanism.
